(19) United States
(12) Patent Application Publication
(10) Pub. No.: US 2026/0060507 A1
(43) Pub. Date: Mar. 5, 2026

(54) DOOR LOCK DEVICE AND ELECTRICAL APPLIANCE

(71) Applicant: ILLINOIS TOOL WORKS INC., GLENVIEW, IL (US)

(72) Inventors: Yang WANG, Dongguan City (CN); Sangui WU, Dongguan City (CN)

(73) Assignee: ILLINOIS TOOL WORKS INC., GLENVIEW, IL (US)

(21) Appl. No.: 19/314,192

(22) Filed: Aug. 29, 2025

(30) Foreign Application Priority Data
Sep. 4, 2024 (CN) 2024112345872
Aug. 18, 2025 (CN) 202511156185X

(51) Int. Cl. A47L 15/42; E05C 3/12; H01H 15/10

(52) U.S. Cl. CPC A47L 15/4274; A47L 15/4259; E05C 3/12; H01H 15/10

(57) ABSTRACT

A door lock device including a switch and a first and a second operating slider. The switch is switchable between a first and a second switch state. The first operating slider includes an actuating portion and is movable between a first and a second position. The second operating slider includes a first actuated portion and a spaced apart second actuated portion, and is movable between the first and second actuated portion. During movement of the first operating slider from the first to the second position, the actuating portion disengages from the first actuated portion and engages with the second actuated portion, the first operating slider drives the second operating slider to move, and upon reaching the second position, switch the switch from the first to the second switch state by the second operating slider. The door lock device ensures that power is supplied only after the door is fully closed.

### CROSS-REFERENCE TO RELATED APPLICATIONS

Chinese Patent Application No. CN 2024112345872, filed on 4 Sep. 2024, the priority document corresponding to this invention, and Chinese Patent Application No. CN 202511156185X, filed on 18 Aug. 2025; to which a foreign priority benefit is claimed to each under Title 35, United States Code, Section 119, and their entire teachings are incorporated, by reference, into this specification.

### BACKGROUND OF THE INVENTION

### Field of the Invention

The present disclosure relates to a door lock device and an electrical appliance, and in particular to a door lock device easy for locking and unlocking of a door of an electrical appliance, and an electrical appliance provided with the door lock device.

### Discussion of Related Art

Electrical appliances such as dishwashers are typically provided with a door lock device on the door thereof. The door lock device cooperates with a door catch on the door to lock the door catch after the door is closed, and to unlock the door catch to allow the door to open. The door lock device is usually provided with a micro switch to detect whether the locking and unlocking operations of the door catch are completed, enabling a control device to control the power-on and power-off of the electrical appliance according to the completion of the locking and unlocking operations of the door. When the electrical appliance is powered on, it starts to work, and when the electrical appliance is powered off, it stops working. The micro switch is a momentary contact switch provided with a movable part (e.g., a button) thereon, and switching of on and off states of the switch requires only a very small actuation travel of the movable part, which is almost negligible. In an application, the door lock device includes a slider, the locking and unlocking of the door are achieved through movement of the slider, the micro switch can be triggered and not triggered by the slider during the movement of the slider, thereby allowing the switching between the on and off states to detect the completion of the locking and unlocking operations of the door on the based on the position of the slider.

### SUMMARY OF THE INVENTION

Through long-term observation and research, the inventors of the present disclosure have found that in the prior art of the above-mentioned application, the position where the door lock slider completes the door locking operation and the position where it completes the door unlocking operation during its movement (i.e., corresponding to the closing point and opening point of the door catch, respectively) do not coincide. Instead, there is a certain distance between them, for example, approximately 2.5 mm. Therefore, in the aforementioned door lock device where the locking and unlocking of the door are achieved through the movement of a single slider, if only one switch is used to detect the completion of both the locking and unlocking operations, it becomes difficult to set the position where the slider triggers the switch. This is because the triggering and non-triggering of the switch by the slider (i.e., the switching between the two states of the switch) almost correspond to the same position of the slider. If the position where the slider triggers the switch is set after the completion of the door locking operation, then after the dishwasher is powered on and starts working, an unintended force in the door-opening direction (e.g., steam pressure) from inside the dishwasher may cause the slider to move and switch the switch to the off state, resulting in the dishwasher being powered off and stopping operation. On the other hand, if the position where the slider triggers the switch is set before the completion of the door locking operation, the slider would trigger the switch before the door locking operation is fully completed, causing the switch to switch from the off state to the on state. This would lead to the dishwasher being powered on and starting operation before the door is securely locked. Clearly, both scenarios are undesirable. To address this, the prior art employs two separate switches. One switch is dedicated to detecting the completion of the door locking operation, and its position is set such that the slider triggers this switch only after the door locking operation is completed, thereby powering on the electrical appliance. The other switch is dedicated to detecting the completion of the door unlocking operation, and its position is set such that the slider triggers this switch only after the door unlocking operation is completed, thereby powering off the electrical appliance. However, incorporating two switches in the door lock device occupies more internal space within the door lock housing or increases the overall dimensions of the housing. This is disadvantageous for the arrangement of internal components of the door lock device and its installation and layout on the electrical appliance.

To at least partially solve the above problem, according to a first aspect of the present disclosure, the present disclosure provides a door lock device for an electrical appliance including a switch, a first operating slider and a second operating slider. The switch is switchable between a first switch state and a second switch state. The first operating slider includes an actuating portion and is movable between a first position and a second position in a first direction. The second operating slider is configured to be movable in the first direction and capable of operating the switch during movement to switch states of the switch. The second operating slider includes a first actuated portion and a second actuated portion spaced apart from each other by a certain distance, and the actuating portion of the first operating slider is movable between the first actuated portion and the second actuated portion and is engageable with the first actuated portion and the second actuated portion respectively. During the movement of the first operating slider from the first position to the second position, the actuating portion of the first operating slider disengages from the first actuated portion and engages with the second actuated portion, the first operating slider thus drives the second operating slider to move, and upon reaching the second position, switch the switch from the first switch state to the second switch state by the second operating slider. During the movement of the first operating slider from the second position to the first position, the actuating portion of the first operating slider disengages from the second actuated portion and engages with the first actuated portion, the first operating slider thus drives the second operating slider to move, and upon reaching the first position, switch the switch from the second switch state to the first switch state by the second operating slider.

According to the first aspect of the present disclosure, the second operating slider is provided with a slot, and a first side wall and a second side wall of the slot that are opposite in the first direction form the first actuated portion and the second actuated portion respectively. The actuating portion is accommodated in the slot.

According to the first aspect of the present disclosure, the first operating slider includes a body portion and a tab extending from the body portion, and the tab forms the actuating portion.

According to the first aspect of the present disclosure, a part of the switch operated by the second operating slider includes a button, and the button is movable in a second direction perpendicular to the first direction to switch the switch between the first switch state and the second switch state.

According to the first aspect of the present disclosure, the door lock device further includes an elastic guide member disposed between the button of the switch and the second operating slider. The second operating slider operatively engages with the elastic guide member, and the elastic guide member operatively engages with the button of the switch, such that the elastic guide member is capable of converting a driving force along the first direction from the second operating slider into a pressing force along the second direction applied to the button of the switch.

According to the first aspect of the present disclosure, the elastic guide member is an elastic guide piece including an inclined guide portion and a pressing portion connected to each other. The pressing portion is located above the button, and the inclined guide portion is located on one side of the button and extends obliquely relative to the first direction.

According to the first aspect of the present disclosure, the second operating slider includes an engagement surface. The engagement surface extends obliquely relative to the first direction and is in the same inclination direction as the inclined guide portion. The second operating slider starts to apply the pressing force to the button of the switch by means of engagement of the engagement surface with the inclined guide portion.

According to the first aspect of the present disclosure, the moving distance of the first operating slider between the first position and the second position is S1, the moving distance of the second operating slider driven by the first operating slider is S2, and the moving distance of the actuating portion of the first operating slider between the first actuated portion and the second actuated portion of the second operating slider is S3, and S1=S2+S3.

According to the first aspect of the present disclosure, the first switch state is a state in which the electrical appliance is powered off, and the second switch state is a state in which the electrical appliance is powered on.

According to the first aspect of the present disclosure, the first operating slider is configured, when a door of the electrical appliance is pushed and pulled to perform door closing and opening operations, to move from the first position to the second position in a door closing direction and to move from the second position to the first position in a door opening direction under the drive of the door of the electrical appliance. The door closing direction and the door opening direction are opposite directions in the first direction. The first operating slider further includes a third position and a fourth position that are located between the first position and the second position and are close to the first position and the second position respectively. During the movement of the first operating slider in the door closing direction, when the first operating slider reaches the fourth position, the first operating slider is captured to lock the door of the electrical appliance. During the movement of the first operating slider in the door opening direction, when the first operating slider reaches the third position, the first operating slider is released to unlock the door of the electrical appliance.

According to the first aspect of the present disclosure, in the door opening direction, a part of the switch operated by the second operating slider is located downstream of the second operating slider.

According to the first aspect of the present disclosure, the door lock device further includes: a housing, and the switch, the first operating slider and the second operating slider being accommodated in the housing; and a pair of locking arms, at least a part of the pair of locking arms being accommodated in the housing and extending out from the housing, and the pair of locking arms being rotatably connected to the first operating slider and being rotatable relative to each other to achieve locking and unlocking of the door of the electrical appliance.

According to the first aspect of the present disclosure, the door lock device further includes a capture element accommodated in the housing and including a locking protrusion. The first operating slider includes a locking recess, and the locking protrusion is engageable with and disengageable from the locking recess. The capture element is movable between a capture position where the locking protrusion engages with the locking recess to capture the first operating slider and thus block the movement of the first operating slider, locking the door of the electrical appliance, and a release position where the locking protrusion disengages from the locking recess to release the first operating slider and thus allow the first operating slider to move, unlocking the door of the electrical appliance.

According to the first aspect of the present disclosure, the second operating slider and the capture element are arranged on opposite sides of the first operating slider.

According to a second aspect of the present disclosure, the present disclosure provides an electrical appliance including a door lock device as aforementioned.

The present disclosure provides a second operating slider between the first operating slider and the switch, enabling the use of only one switch in the door lock housing to allow the first operating slider to operate the switch and switch its state at two different sliding positions, thereby optimizing the internal space of the door lock housing.

### BRIEF DESCRIPTION OF SEVERAL VIEWS OF THE DRAWINGS

The features and advantages of the present disclosure can be better understood by reading the following detailed description with reference to the accommodating drawings. Like reference signs denote like components throughout the drawings, in which:

FIG. 1 is a schematic diagram of a dishwasher having a door lock device according to the present disclosure;

FIG. 2 is a perspective view of an embodiment of the door lock device according to the present disclosure;

FIG. 3A is a perspective assembly view of a first operating slider, a second operating slider, a switch and an elastic guide member of the door lock device shown in FIG. 2;

FIG. 3B is an exploded view of the first operating slider, the second operating slider, the switch and the elastic guide member of the door lock device shown in FIG. 2;

FIG. 3C is a sectional view of the second operating slider shown in FIG. 3B taken along line A-A;

FIG. 4A is a side view of the first operating slider of the door lock device according to the present disclosure in a first position;

FIG. 4B is a simplified illustrative view of a partially enlarged part in FIG. 4A;

FIG. 5A is a side view of the first operating slider of the door lock device according to the present disclosure in a fourth position;

FIG. 5B is a simplified illustrative view of a partially enlarged part in FIG. 5A;

FIG. 6A is a side view of the first operating slider of the door lock device according to the present disclosure in a second position;

FIG. 6B is a simplified illustrative view of a partially enlarged part in FIG. 6A;

FIG. 7A is a side view of the first operating slider of the door lock device according to the present disclosure in a third position;

FIG. 7B is a simplified illustrative view of a partially enlarged part in FIG. 7A; and

FIG. 8 is a schematic diagram of a relative relationship between movement positions of the first operating slider.

### DESCRIPTION OF PREFERRED EMBODIMENTS

Various specific embodiments of the present disclosure will be described below with reference to the drawings which form part of this specification. It should be understood that although the terms indicating directions, such as “front”, “rear”, “upper”, “lower”, “left”, “right”, “top”, and “bottom” are used in the present disclosure to describe structural parts and elements in various examples of the present disclosure, these terms are used herein only for ease of illustration and are determined based on the exemplary orientations shown in the accompanying drawings. Since the arrangements in the embodiments disclosed in the present disclosure may be in various directions, these terms indicating directions are only illustrative and should not be considered as limitations.

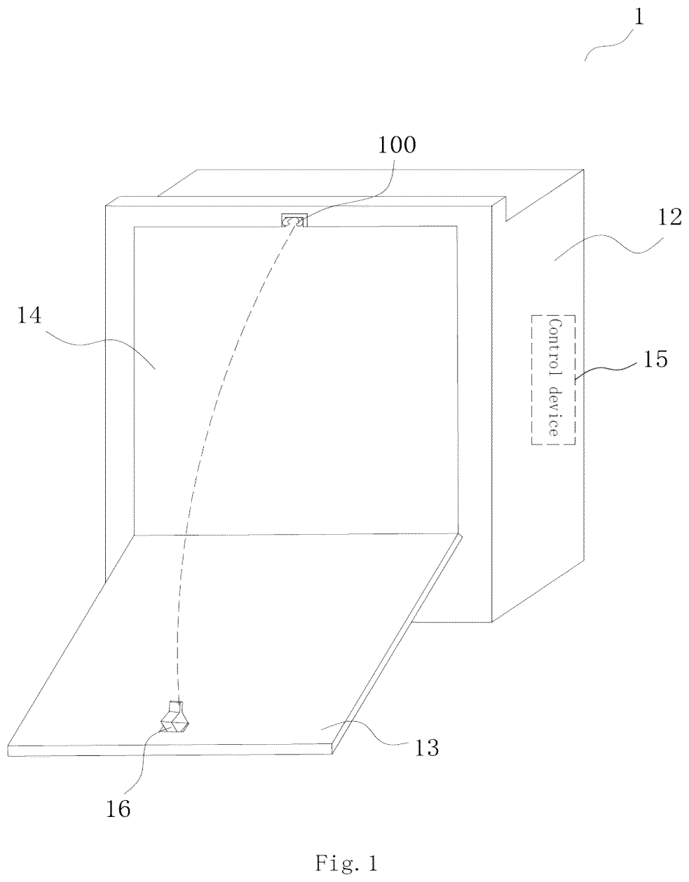

FIG. 1 is a schematic diagram of a dishwasher having a door lock device according to the present disclosure.

As shown in FIG. 1, the dishwasher 1 has a dishwasher housing 12, a door 13, a dishwasher accommodation cavity 14 inside the dishwasher housing 12, and the door lock device 100, where a door catch 16 is provided on the door 13, and the door lock device 100 is arranged on the dishwasher body 12. As the door 13 is pushed to be closed, the door catch 16 is captured and locked by the door lock device 100, and accordingly the door 13 is closed and locked in a closed position. A control device 15 is provided on the dishwasher housing 12, and can control the start and stop of operating components of the dishwasher according to received switch triggering signals of the door lock device 100.

The dishwasher 1 shown in FIG. 1 is merely exemplary, and the door lock device 100 of the present disclosure may also be mounted on various types of electrical appliances each having a cavity and a door for closing the cavity, such as a washing machine, a dryer, a microwave oven, and so on, and may also be mounted on other non-electrical appliances.

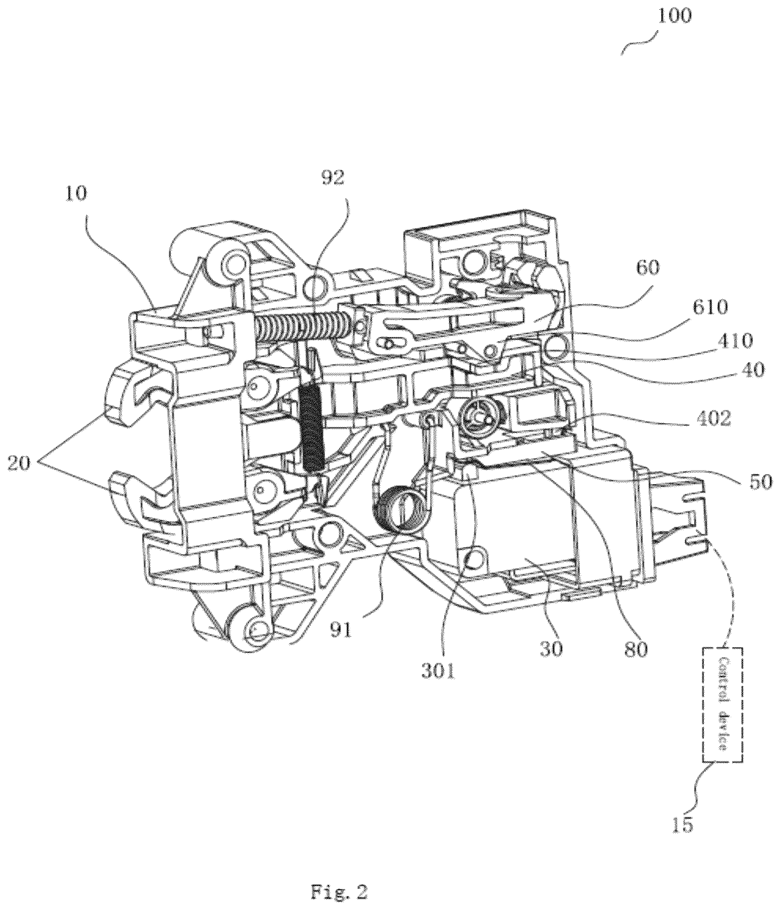

FIG. 2 shows a perspective view of an embodiment of the door lock device 100 according to the present disclosure. In order to show various components inside the door lock device 100, an upper cover of a housing of the door lock device is not shown in the figure.

As shown in FIG. 2, the door lock device 100 includes the housing 10, a pair of locking arms 20, a switch 30, a first operating slider 40, a second operating slider 50, a capture element 60 and an elastic guide member 80. The switch 30, the first operating slider 40, the second operating slider 50, the capture element 60 and the elastic guide member 80 are accommodated in the housing 10. At least a part of the pair of locking arms 20 is accommodated in the housing 10. The second operating slider 50 and the capture element 60 are arranged on opposite sides of the first operating slider 40. The pair of locking arms 20, the first operating slider 40 and the capture element 60 cooperate with one another to allow locking and unlocking of the door 13. The switch 30, the first operating slider 40, the second operating slider 50 and the elastic guide member 80 cooperate with one another to control states of the switch 30.

Still as shown in FIG. 2, one end of each of the pair of locking arms 20 is rotatably connected to the left end of the first operating slider 40, and the other end thereof extends out from the housing 10. By means of the rotation of the pair of locking arms 2 relative to each other, the door catch can be captured and released, and thus the door of the electrical appliance is locked and unlocked. The switch 30 is in communication with the control device 15 and can be switched between a first switch state and a second switch state, and thus different switch state signals are transmitted to the control device 15 to control the operation of the dishwasher. In an embodiment of the present disclosure, when the switch 30 is in the first switch state, the switch 30 is turned off itself, and the electrical appliance is powered off by the switch 30. When the switch 30 is in the second switch state, the switch 30 is turned on itself, and the electrical appliance is powered on by the switch 30.

Still as shown in FIG. 2, the first operating slider 40 includes an actuating portion 402 configured to drive the second operating slider 50. The first operating slider 40 is movable between a first position and a second position in a first direction. In the illustrated embodiment, the first position is a position where the switch 30 is turned off, the second position is a position where the switch 30 is turned on, and the first operating slider 40 moves between the first position and the second position by a distance S1. The second operating slider 50 is movably arranged in the first direction and moves under the drive of the first operating slider 40. The second operating slider 50 can operate the switch 30 during the movement to switch the states of the switch 30. In the illustrated embodiment, the first operating slider 40 can drive the second operating slider 50 to move by a distance S2.

When the door of the electrical appliance is pushed and pulled to perform door closing and opening operations, under the drive of the door of the electrical appliance, the first operating slider 40 moves from the first position to the second position in a door closing direction and moves from the second position to the first position in a door opening direction. The door closing direction and the door opening direction are opposite in the first direction. In the door opening direction, a part of the switch 30 operated by the second operating slider 50 is located downstream of the second operating slider 40.

The first operating slider 40 further includes a third position and a fourth position which are located between the first position and the second position and respectively close to the first position and the second position. During the movement of the first operating slider 40 in the door closing direction, when the first operating slider 40 reaches the fourth position, the first operating slider 40 is captured by the capture element 60 to lock the door of the electrical appliance, that is, complete the locking operation. During the movement of the first operating slider 40 in the door opening direction, when the first operating slider 40 reaches the third position, the capture element 60 releases the first operating slider 40 to unlock the door of the electrical appliance, that is, complete the unlocking operation.

Still as shown in FIG. 2, the capture element 60 includes a locking protrusion 610, the first operating slider 40 includes a locking recess 410, and the locking protrusion 610 can engage with or disengage from the locking recess 410. The capture element 60 is movable between a capture position and a release position. In the capture position, the locking protrusion 610 engages with the locking recess 410 to capture the first operating slider 40 and thus block the movement of the first operating slider 40 in the door opening direction, locking the door of the electrical appliance. In the release position, the locking protrusion 610 disengages from the locking recess 410 to release the first operating slider 40 and thus allow the movement of the first operating slider 40 in the door opening direction, unlocking the door of the electrical appliance.

Still as shown in FIG. 2, the door lock device 100 further includes a first biasing means 91 and a second biasing means 92. The first biasing means 91 is mounted between the first operating slider 40 and the housing 10 and is configured to provide the first operating slider 40 with a biasing force for moving in the door opening direction. The second biasing means 92 is mounted between the capture element 60 and the housing 10 and is configured to provide the capture element 60 with a biasing force for moving in the door closing direction and in a direction of engagement with the first operating slider 40.

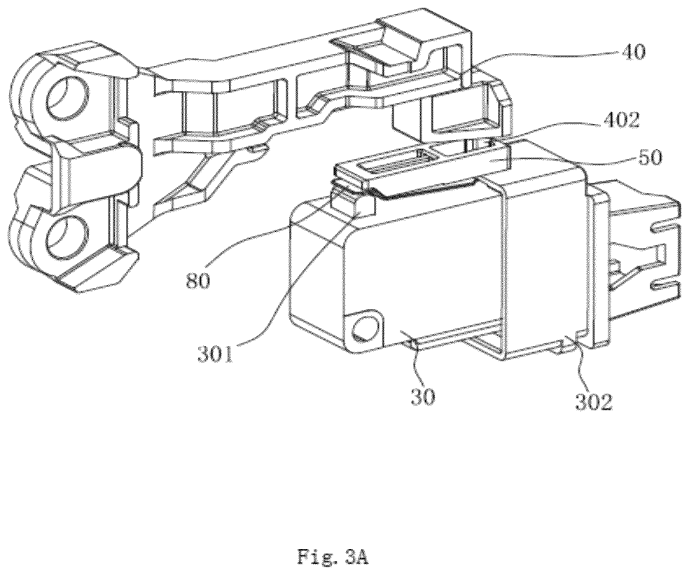

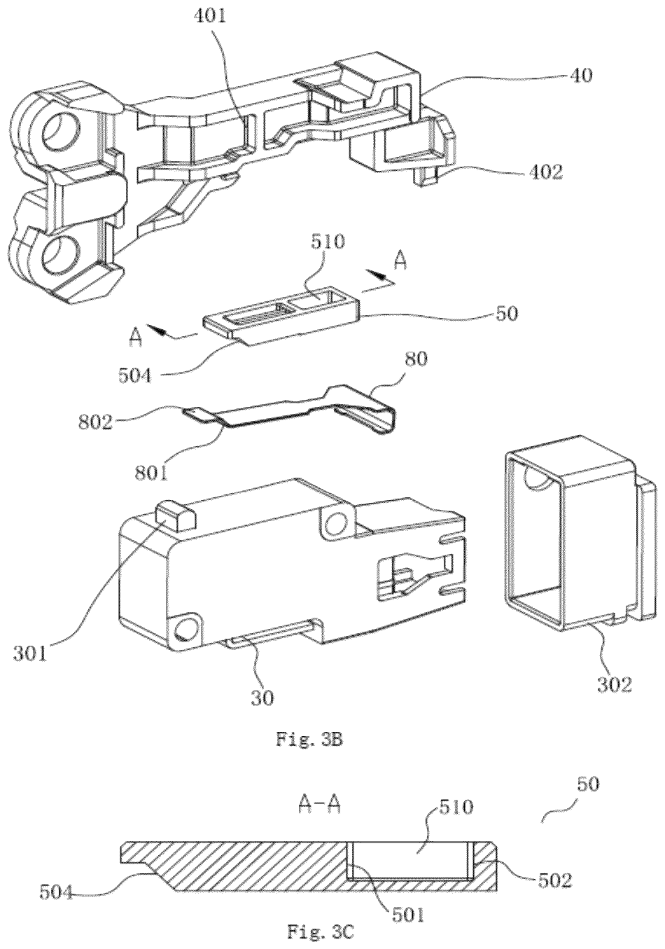

FIGS. 3A-3C show specific structures of the first operating slider 40, the second operating slider 50, the switch 30 and the elastic guide member 80. FIG. 3A is a perspective assembly view of the first operating slider 40, the second operating slider 50, the switch 30 and the elastic guide member 80, FIG. 3B is an exploded view of the first operating slider 40, the second operating slider 50, the switch 30 and the elastic guide member 80, and FIG. 3C is a sectional view of the second operating slider 50 of FIG. 3B taken along line A-A.

As shown in FIGS. 3A-3C, the second operating slider 50 includes a first actuated portion 501 and a second actuated portion 502 spaced apart from each other by a certain distance. The actuating portion 402 of the first operating slider 40 is movable between the first actuated portion 501 and the second actuated portion 502, and is engageable with the first actuated portion 501 and the second actuated portion 502 respectively. The first operating slider 40 includes a body portion 401 and a tab extending from the body portion 401, and the tab forms the actuating portion 402. The second operating slider 50 is provided with a slot 510 for accommodating the actuating portion 402, and a first side wall and a second side wall of the slot 510 that are opposite in the first direction form the first actuated portion 501 and the second actuated portion 502 respectively. In the embodiment of the present disclosure, the actuating portion 402 of the first operating slider 40 moves between the first actuated portion 501 and the second actuated portion 502 of the second operating slider 150 by a distance S3, that is, the first operating slider 40 moves in the slot 510 of the second operating slider 50 by the distance S3, and the distance S1 by which the first operating slider 40 moves between the first position and the second position is equal to a sum of the distance S2 by which the first operating slider 40 drives the second operating slider 50 to move and the distance S3 by which the first operating slider 40 moves in the slot 510 (i.e., S1=S2+S3).

Still as shown in FIGS. 3A-3C, the part of the switch 30 operated by the second operating slider 50 includes a button 301. The button 301 is movable in a second direction perpendicular to the first direction to switch the switch 30 between the first switch state and the second switch state. Specifically, when the button 301 is pressed (the switch is triggered), the switch 30 is switched from the second switch state (the on state in which the electrical appliance is powered on) to the first switch state (the off state in which the electrical appliance is powered off). When the button 301 is released and pops up (the switch is not triggered), the switch 30 is switched from the first switch state (the off state in which the electrical appliance is powered off) to the second switch state (the on state in which the electrical appliance is powered on). The switch 30 further includes a mounting frame 302 configured for fixedly installing the switch 30 in the housing 10, while maintaining a fixed end of the elastic guide member 80 secured to the switch 30.

Still as shown in FIGS. 3A-3C, the elastic guide member 80 is an elastic guide piece having a metal sheet structure. The elastic guide member 80 is disposed between the button 301 of the switch 30 and the second operating slider 50. The second operating slider 50 operatively engages with the elastic guide member 80, and the elastic guide member 80 operatively engages with the button 301 of the switch 30, such that the elastic guide member 80 can convert a driving force along the first direction from the second operating slider 50 into a pressing force along the second direction applied to the button 301. The elastic guide member 80 includes an inclined guide portion 801 and a pressing portion 802 that are connected to each other. The pressing portion 802 is located above the button 301, and the inclined guide portion 801 is located on one side of the button 301 and extends obliquely relative to the first direction. The second operating slider 50 includes an engagement surface 504 which extends obliquely relative to the first direction and is in the same inclination direction as the inclined guide portion 801. The second operating slider 50 starts to apply a pressing force to the button 301 of the switch 30 by means of engagement of the engagement surface 504 with the inclined guide portion 801.

It should be understood by those skilled in the art that in some other embodiments, the elastic guide member 80 may be omitted. Instead, an actuating ramp is provided on the second operating slider 50, so that the movement of the second operating slider 50 directly presses or releases the button 301 of the switch 30

During the movement of the first operating slider 40 from the first position to the second position in the door closing direction, the actuating portion 402 of the first operating slider 40 disengages from the first actuated portion 501 and engages with the second actuated portion 502, the first operating slider 40 thus drives the second operating slider 50 to move in the door closing direction, and upon reaching the second position, switch the switch 30 from the first switch state (the state in which the electrical appliance is powered off) to the second switch state (the state in which the electrical appliance is powered on) by the second operating slider 50. During the movement of the first operating slider 40 from the second position to the first position in the door opening direction, the actuating portion 402 of the first operating slider 40 disengages from the second actuated portion 502 and engages with the first actuated portion 501, the first operating slider 40 thus drives the second operating slider 50 to move in the door opening direction, and upon reaching the first position, switch the switch 30 from the second switch state (the state in which the electrical appliance is powered on) to the first switch state (the state in which the electrical appliance is powered off) by the second operating slider 50.

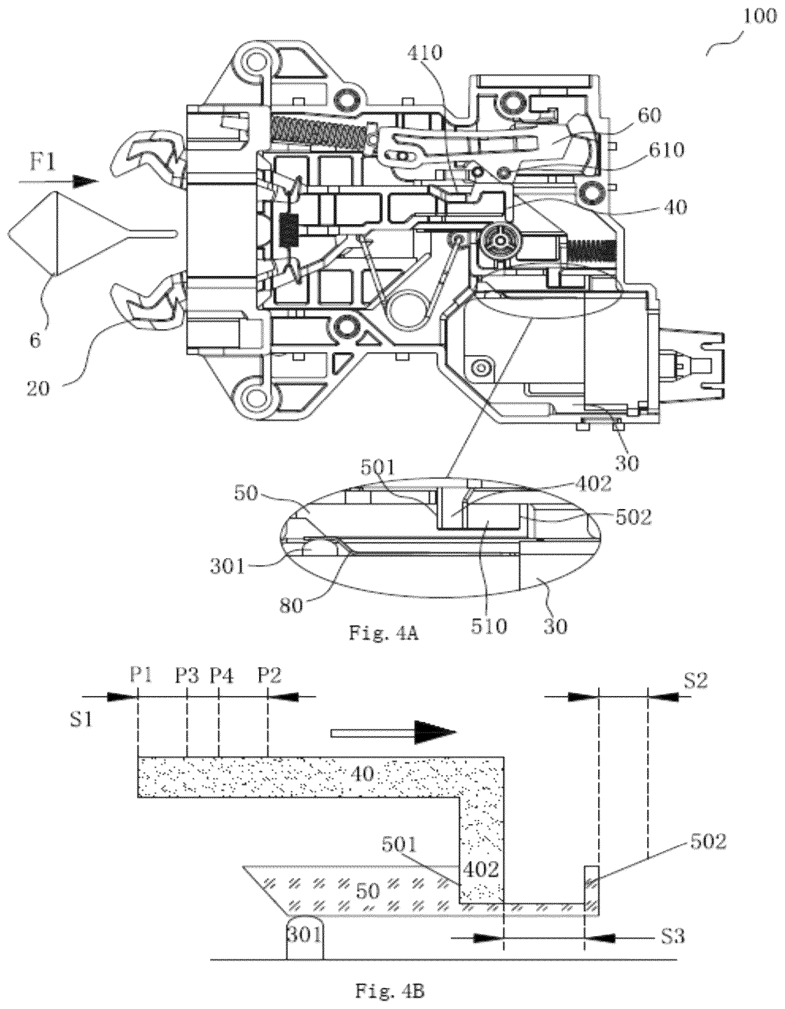

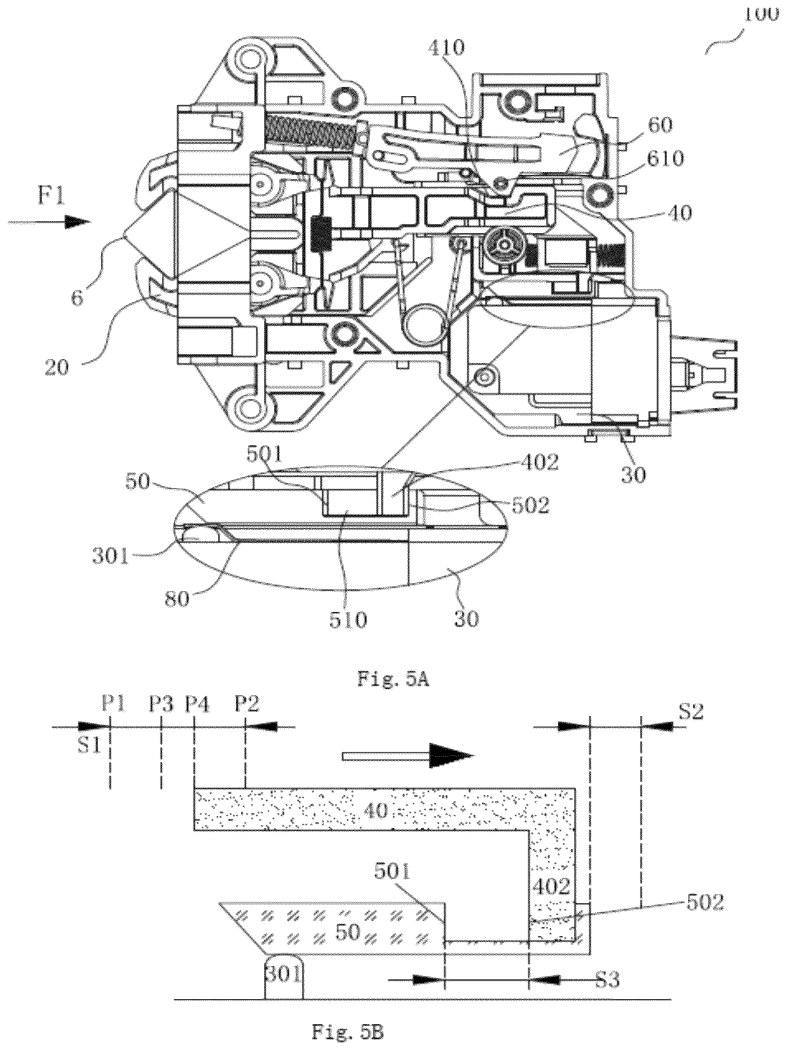

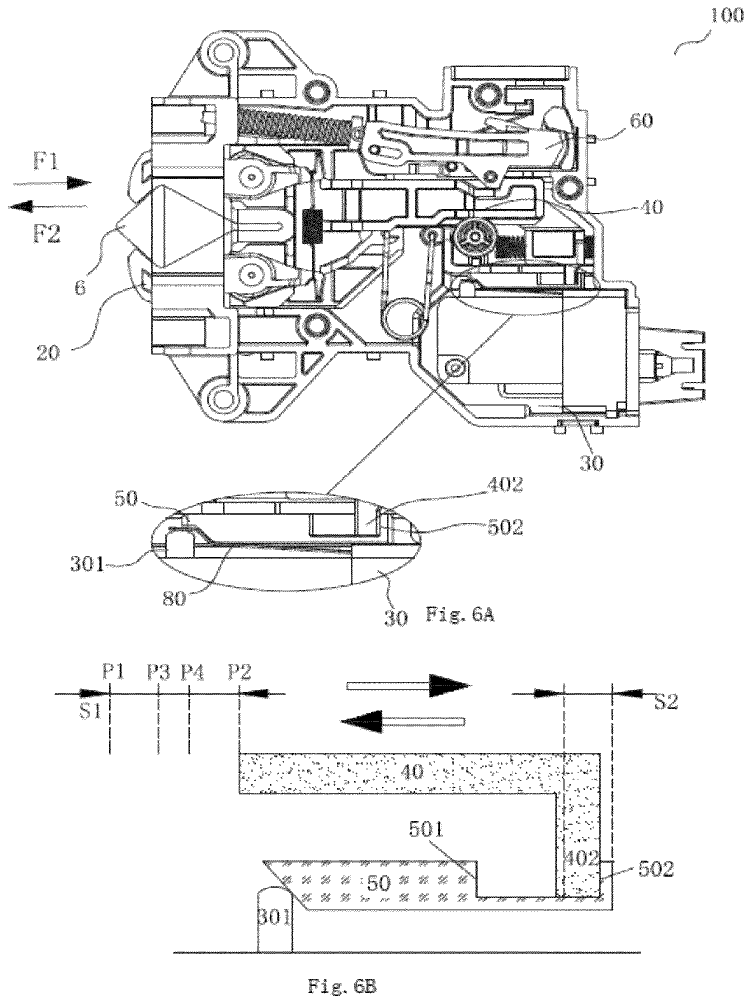

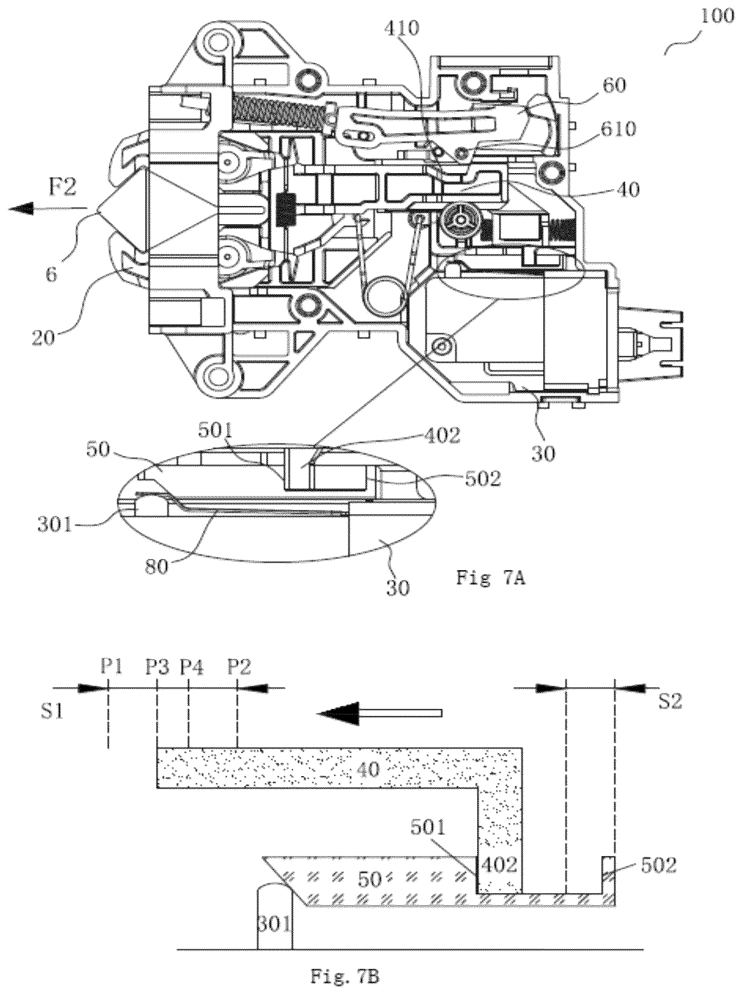

FIGS. 4A-7B show the cooperation relationship of the components during the movements of the first operating slider of the door lock device of the present disclosure from the first position to the second position and from the second position to the first position. FIG. 4A is a side view of the first operating slider of the door lock device according to the present disclosure in the first position, and FIG. 4B is a simplified illustrative view of a partially enlarged part in FIG. 4A. FIG. 5A is a side view of the first operating slider of the door lock device according to the present disclosure in the fourth position, and FIG. 5B is a simplified illustrative view of a partially enlarged part in FIG. 5A. FIG. 6A is a side view of the first operating slider of the door lock device according to the present disclosure in the second position, and FIG. 6B is a simplified illustrative view of a partially enlarged part in FIG. 6A. FIG. 7A is a side view of the first operating slider of the door lock device according to the present disclosure in the third position, and FIG. 7B is a simplified illustrative view of a partially enlarged part in FIG. 7A.

In the simplified illustrative views 4B, 5B, 6B and 7B, the elastic guide member 80 is removed to more clearly show the relative positional relationship of the first operating slider 40, the second operating slider 50 and the button 301 of the switch 30.

For the ease of illustration of movement positions of the first operating slider 40, the simplified illustrative views use P1-P4 to represent the movement positions respectively with the left end of the first operating slider 40 as a reference point. Among them, P1 represents the first position, that is, the position for turning off the switch. P2 represents the second position, that is, the position for turning on the switch. P3 represents the third position, that is, the position for unlocking the door. P4 represents the fourth position, that is, the position for locking the door. The door is in an unlocked state when the first operating slider 40 is in P1, and the door is in a locked state when the first operating slider 40 is in P2.

As shown in FIGS. 4A-4B, when the door of the electrical appliance is in an open state, the first operating slider 40 is in the first position. The locking protrusion 610 of the capture element 60 disengages from the locking recess 410 of the first operating slider 40, and the first operating slider 40 is in a released state because the first operating slider is not captured by the capture element 60. The second operating slider 50 presses the button 301 of the switch 30 by means of the elastic guide member 80, allowing the switch 30 to be in the first switch state, and thus powering off the electrical appliance. The actuating portion 402 of the first operating slider 40 abuts against the first side wall (the first actuated portion 501) of the slot 510 of the second operating slider 50. In this state, the door closing operation is performed, and the door catch 6 is subjected to a pushing force F1 toward the pair of locking arms 20 and thus moves toward the position shown in FIGS. 5A-5B. The door catch 6 pushes the first operating slider 40 such that the actuating portion 402 of the first operating slider 40 moves in the slot 510 toward the second side wall (the second actuated portion 502).

As shown in FIGS. 5A-5B, under the action of the pushing force F1, the door catch 6 is captured by the pair of locking arms 20, and the actuating portion 402 of the first operating slider 40 moves to the fourth position in the slot 510 of the second operating slider 50, and does not drive the second operating slider 50 to move. The actuating portion 402 of the first operating slider 40 moves from a position where the actuating portion abuts against the first side wall (the first actuated portion 501) of the slot 510 to a position where the actuating portion is in contact with the second side wall (the second actuated portion 502), and a displacement distance of the actuating portion 402 is S3. Since the second operating slider 50 does not move, the button 301 of the switch 30 is still pressed by the elastic guide member 80, allowing the switch 30 to be in the first switch state and keeping the electrical appliance powered off.

Still as shown in FIG. 5A, when the fourth position is reached, the first operating slider 40 is in a captured state. The locking protrusion 610 of the capture element 60 engages with the locking recess 410 of the first operating slider 40 to capture the first operating slider 40. After the locking protrusion 610 engages with the locking recess 410, if the pushing force F1 is removed, the first operating slider 40 will continue to move in the door closing direction under the action of the capture element 60, such that the door of the electrical appliance can be closed automatically instead of opening.

As shown in FIGS. 6A-6B, the first operating slider 40 moves further in the door closing direction under the action of the pushing force F1 or the capture element 60 to reach the second position. Since the actuating portion 402 of the first operating slider 40 abuts against the second side wall (the second actuated portion 502), the first operating slider 40 drives the second operating slider 50 to move together by the distance S2 in the door closing direction. In this case, the second operating slider 50 stops pressing the button 301 of the switch 30 by the elastic guide member 80, the button 301 is released and pops up, switching the switch 30 from the first switch state to the second switch state and thus powering on the electrical appliance.

The door opening operation is performed in the position shown in FIGS. 6A-6B, the door catch 6 is subjected to a pulling force F2 away from the pair of locking arms 20 and thus moves toward the position shown in FIGS. 7A-7B. The pair of locking arms 20 pulls the first operating slider 40 in the door opening direction under the pulling force of the door catch 6. Since the locking recess 410 of the first operating slider 40 remains locked with the locking protrusion 610 of the capture element 60, the first operating slider 40 also pulls the capture element 60 to move together in the door opening direction.

As shown in FIGS. 7A-7B, the first operating slider 40 reaches the third position thereof, and at this point, the first operating slider 40 is in the position for unlocking the door. During the movement from the second position shown in FIGS. 6A-6B to the third position shown in FIGS. 7A-7B, the actuating portion 402 of the first operating slider 40 moves in the slot 510 of the second operating slider 50 from the position where the actuating portion abuts against the second side wall (the second actuated portion 502) to the position where the actuating portion abuts against the first side wall (the first actuated portion 501), but the second operating slider 50 does not move. Therefore, the button 301 of the switch 30 is still released and pops up, the switch 30 remains in the second switch state, and the electrical appliance remains powered on.

If the pulling force F2 continues to be applied in the state shown in FIGS. 7A-7B, the movement of the first operating slider 40 in the door opening direction causes the locking recess 410 of the first operating slider to disengage from the locking protrusion 610 of the capture element 60, and the first operating slider 40 will move to the first position shown in FIGS. 4A-4B. In this process, since the actuating portion 402 of the first operating slider 40 abuts against the first side wall (the first actuated portion 501), the first operating slider 40 drives the second operating slider 50 to move together by the distance S2 in the door opening direction. Thus, as shown in FIGS. 4A-4B, the second operating slider 50 presses the button 301 of the switch 30 by the elastic guide member 80, switching the switch 30 from the second switch state to the first switch state, and thus powering off the electrical appliance.

In the illustrated embodiment, when the first operating slider 40 moves to the fourth position in the door closing direction, the actuating portion 402 of the first operating slider 40 abuts against the second side wall (the second actuated portion 502) of the slot 510. When the first operating slider 40 moves to the third position in the door opening direction, the actuating portion 402 of the first operating slider 40 abuts against the first side wall (the first actuated portion 501) of the slot 510. It should be understood by those skilled in the art that, in some other embodiments, by adjusting a distance between the button 301 of the switch 30 and the second operating slider 50, when the first operating slider 40 is in the fourth position, the actuating portion 402 thereof may also not abut against the second side wall of the slot 510, or before the first operating slider 40 moves to the fourth position, the actuating portion 402 thereof has already abutted against the second side wall of the slot 510. When the first operating slider 40 is in the third position, the actuating portion 402 thereof may also not abut against the first side wall of the slot 510, or before the first operating slider 40 moves to the third position, the actuating portion 402 thereof has already abutted against the first side wall of the slot 510.

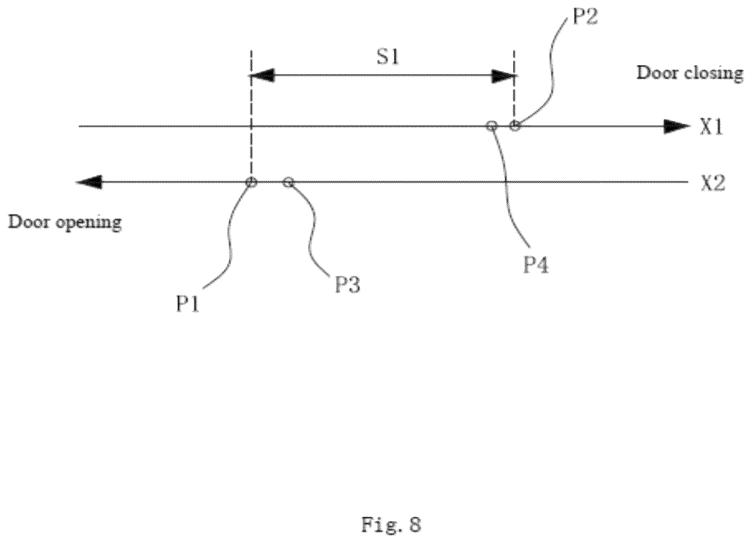

FIG. 8 is a schematic diagram of a relative relationship between movement positions of the first operating slider.

As shown in FIG. 8, a coordinate axis X1 represents the movement of the first operating slider in a door closing process, and a coordinate axis X2 represents the movement of the first operating slider in a door opening process. The second position P2 for turning on the switch is located on the right side of the fourth position P4, that is, when the first operating slider is in the fourth position P4 (the door locking operation has just been completed), the switch is still in the first switch state, and thus the electrical appliance remains in the powered-off state. Only when the first operating slider in the fourth position P4 continues to move in the door closing direction, that is, the door is further closed, to move the first operating slider to the position P2 for turning on the switch, the switch can be switched to the second switch state, and thus the electrical appliance is powered on. Such a configuration has the advantages of ensuring that the electrical appliance can be powered on and start working when the door is in the closed state, and preventing the electrical appliance from being powered on and starting to work when the door has not been closed.

Still as shown in FIG. 8, in the door opening process, the first position P1 for turning off the switch is located on the left side of the third position P3, that is, when the first operating slider moves to the third position P3 (the unlocking operation of the door has just been completed), the switch is still in the second switch state, and thus the electrical appliance remains powered on. Only when the first operating slider in the third position P3 continues to move to the first position P1 in the door opening direction, that is, when the door is unlocked and then further opened, the switch can be switched to the first switch state, and thus the electrical appliance is powered off. Such a configuration has the advantages of ensuring that when the door is improperly operated (for example, due to a pushing force of an internal expansion gas or an accidental door pulling operation of a child), even if the first operating slider moves by a very small distance from the second position P2 in the door opening direction (the first operating slider will not unlocked accordingly), the electrical appliance will not suddenly powered off and stops working.

In addition to the first operating slider, the door lock device of the present disclosure is further provided with the second operating slider. The second operating slider includes the first actuated portion and the second actuated portion spaced apart by a certain distance. The first operating slider is movable relative to the second operating slider to engage with the first actuated portion and the second actuated portion of the second operating slider through the actuating portion thereof, respectively. As a result, the first operating slider can operate the same switch at two different positions spaced apart by a certain distance by means of the second operating slider, such that the turn-on and turn-off of the switch correspond to the two different positions of the first operating slider. Thus, the door lock device of the present disclosure can ensure that the electrical appliance can be powered on for working by using only one switch after the door is locked, and can be powered off to stop working after the door is unlocked.

Moreover, by arranging the elastic guide piece with the inclined surface between the second operating slider and the button of the switch, the driving force of the second operating slider along the first direction can be converted into the pressing force along the direction perpendicular to the first direction applied to the button, so as to ensure smooth pressing on the button. Furthermore, since the elastic guide piece is of the metal sheet structure, the elastic guide piece takes up almost no space between the second operating slider and the button of the switch, without increasing a space requirement of the door lock device.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting. Therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

1. A door lock device for an electrical appliance, comprising:
a switch switchable between a first switch state and a second switch state;
a first operating slider comprising an actuating portion and being movable between a first position and a second position in a first direction; and
a second operating slider configured to be movable in the first direction and capable of operating the switch during movement to switch states of the switch, the second operating slider comprising a first actuated portion and a second actuated portion spaced apart from each other by a certain distance, and the actuating portion of the first operating slider being movable between the first actuated portion and the second actuated portion and being engageable with the first actuated portion and the second actuated portion respectively;
wherein during the movement of the first operating slider from the first position to the second position, the actuating portion of the first operating slider disengages from the first actuated portion and engages with the second actuated portion, the first operating slider thus drives the second operating slider to move, and upon reaching the second position, switch the switch from the first switch state to the second switch state by the second operating slider; and
wherein during the movement of the first operating slider from the second position to the first position, the actuating portion of the first operating slider disengages from the second actuated portion and engages with the first actuated portion, the first operating slider thus drives the second operating slider to move, and upon reaching the first position, switch the switch from the second switch state to the first switch state by the second operating slider.

2. The door lock device of claim 1, wherein
the second operating slider is provided with a slot, and a first side wall and a second side wall of the slot that are opposite in the first direction form the first actuated portion and the second actuated portion respectively; and
wherein the actuating portion is accommodated in the slot.

3. The door lock device of claim 2, wherein
the first operating slider comprises a body portion and a tab extending from the body portion, the tab forming the actuating portion.

4. The door lock device of claim 1, wherein
a part of the switch operated by the second operating slider comprises a button, the button being movable in a second direction perpendicular to the first direction to switch the switch between the first switch state and the second switch state.

5. The door lock device of claim 4, further comprising:
an elastic guide member disposed between the button of the switch and the second operating slider, wherein the second operating slider operatively engages with the elastic guide member, and the elastic guide member operatively engages with the button of the switch, such that the elastic guide member is capable of converting a driving force along the first direction from the second operating slider into a pressing force along the second direction applied to the button of the switch.

6. The door lock device of claim 5, wherein
the elastic guide member is an elastic guide piece comprising an inclined guide portion and a pressing portion connected to each other, the pressing portion being located above the button, and the inclined guide portion being located on one side of the button and extending obliquely relative to the first direction.

7. The door lock device of claim 6, wherein
the second operating slider comprises an engagement surface, the engagement surface extending obliquely relative to the first direction and being in the same inclination direction as the inclined guide portion;
wherein the second operating slider starts to apply the pressing force to the button of the switch by means of engagement of the engagement surface with the inclined guide portion.

8. The door lock device of claim 1, wherein
the moving distance of the first operating slider between the first position and the second position is S1, the moving distance of the second operating slider driven by the first operating slider is S2, and the moving distance of the actuating portion of the first operating slider between the first actuated portion and the second actuated portion of the second operating slider is S3, wherein S1=S2+S3.

9. The door lock device of claim 1, wherein
the first switch state is a state in which the electrical appliance is powered off, and the second switch state is a state in which the electrical appliance is powered on.

10. The door lock device of claim 9, wherein
the first operating slider is configured, when a door of the electrical appliance is pushed and pulled to perform door closing and opening operations, to move from the first position to the second position in a door closing direction and to move from the second position to the first position in a door opening direction under the drive of the door of the electrical appliance, wherein the door closing direction and the door opening direction are opposite directions in the first direction;
wherein the first operating slider further comprises a third position and a fourth position that are located between the first position and the second position and are close to the first position and the second position respectively;
wherein during the movement of the first operating slider in the door closing direction, when the first operating slider reaches the fourth position, the first operating slider is captured to lock the door of the electrical appliance; and
wherein during the movement of the first operating slider in the door opening direction, when the first operating slider reaches the third position, the first operating slider is released to unlock the door of the electrical appliance.

11. The door lock device of claim 10, wherein
in the door opening direction, a part of the switch operated by the second operating slider is located downstream of the second operating slider.

12. The door lock device of claim 10, further comprising:
a housing, the switch, the first operating slider and the second operating slider being accommodated in the housing; and
a pair of locking arms, at least a part of the pair of locking arms being accommodated in the housing and extending out from the housing, and the pair of locking arms being rotatably connected to the first operating slider and being rotatable relative to each other to achieve locking and unlocking of the door of the electrical appliance.

13. The door lock device of claim 12, further comprising:
a capture element accommodated in the housing and comprising a locking protrusion;
wherein the first operating slider comprises a locking recess, and the locking protrusion is engageable with and disengageable from the locking recess; and
wherein the capture element is movable between a capture position where the locking protrusion engages with the locking recess to capture the first operating slider and thus block the movement of the first operating slider, locking the door of the electrical appliance, and a release position where the locking protrusion disengages from the locking recess to release the first operating slider and thus allow the first operating slider to move, unlocking the door of the electrical appliance.

14. The door lock device of claim 13, wherein
the second operating slider and the capture element are arranged on opposite sides of the first operating slider.

15. An electrical appliance, comprising a door lock device of claim 1.
